(19) United States
(12) Patent Application Publication
(10) Pub. No.: US 2014/0205917 A1
(43) Pub. Date: Jul. 24, 2014

(54) METAL-AIR BATTERY

(71) Applicant: Fuminori Mizuno, Susono-shi (JP)

(72) Inventor: Fuminori Mizuno, Susono-shi (JP)

(73) Assignee: TOYOTA JIDOSHA KABUSHIKI KAISHA, Toyota-shi, Aichi (JP)

(21) Appl. No.: 14/123,115

(22) PCT Filed: Sep. 29, 2011
(86) PCT No.: PCT/JP2011/072439

§ 371 Date: Mar. 4, 2014

(51) Int. Cl. H01M 12/08

(52) U.S. Cl. CPC H01M 12/08
USPC 429/405; 429/403

(57) ABSTRACT

To provide a metal-air battery which allows rapid and efficient supply of a liquid electrolyte to an air electrode and an increase in charge-discharge capacity. Disclosed is a metal-air battery including an air electrode layer, a negative electrode layer and an electrolyte layer, the electrolyte layer being present between the air electrode layer and the negative electrode layer, wherein the electrolyte layer includes a separator and a liquid electrolyte, the separator having insulating properties and a porous structure, and the liquid electrolyte being infiltrated in the separator, and wherein a liquid electrolyte reservoir layer is present between the separator and the air electrode layer, the liquid electrolyte reservoir layer having a porous structure which is larger in pore diameter than the separator.

### TECHNICAL FIELD

The present invention relates to a metal-air battery.

### BACKGROUND ART

A metal-air battery which uses oxygen as a positive electrode active material, has such advantages that the battery has high energy density and it is easy to reduce the size and weight, for example. Accordingly, it has attracted attention as a high-capacity battery with greater capacity than lithium secondary batteries widely used now. Known metal-air batteries are a lithium-air battery, a magnesium-air battery, a zinc-air battery, etc.

A metal-air battery can charge and discharge because oxidation-reduction reaction of oxygen is conducted in an air electrode (positive electrode) and oxidation-reduction reaction of metal contained in a negative electrode is conducted in the negative electrode. For example, in the case of a metal-air battery (secondary battery) in which migrating ions are monovalent metal ions, the following charge-discharge reaction is thought to proceed. In the following formula, “M” means a metal species.

### [Upon Discharge]

Negative electrode: M→M⁺+e⁻

Air electrode: 2M⁺+O₂+2e⁻→M₂O₂

### [Upon Charge]

Negative electrode: M⁺+e⁻→M

Air electrode: M₂O₂→2M⁺+O₂+2e⁻

An air battery comprises the following, for example; an air electrode layer comprising an electroconductive material and a binder; an air electrode current collector for collecting current from the air electrode layer; a negative electrode layer comprising a negative electrode active material (such as metal or alloy); a negative electrode current collector for collecting current from the negative electrode layer; and an electrolyte that is present between the air electrode layer and the negative electrode layer.

Concrete examples of metal-air batteries include those disclosed in Patent Literatures 1 to 6, for example.

Disclosed in Patent Literature 1 is a metal-air battery comprising a positive electrode layer, a negative electrode layer and a non-aqueous electrolyte layer, the non-aqueous electrolyte layer being present between the positive and negative electrode layers and comprising a non-aqueous liquid electrolyte and a separator that is infiltrated with and retains the non-aqueous liquid electrolyte.

Disclosed in Patent Literature 5 is a metal-air battery comprising: a battery case with air inlet pores; an electrode group that contains a positive electrode, a negative electrode and a separator present between the positive and negative electrodes; and an air gap retaining member present between the pores-formed side of the battery case and the positive electrode.

Disclosed in Patent Literature 6 is a battery electrode comprising: a porous current collector; an inner electrode layer being formed below the surface of the porous current collector and comprising a second electrode material which has a particle size that is smaller than the aperture diameter of the porous current collector; and an outer electrode layer being formed on the inner electrode layer and comprising a first electrode material having a particle size larger than the aperture diameter of the porous current collector.

### Citation List

Patent Literature 1: Japanese Patent Application Laid-Open (JP-A) No. 2002-15782
Patent Literature 2: JP-A No. 2010-103064
Patent Literature 3: International Publication No. WO2007-21717
Patent Literature 4: JP-A No. H09-306509
Patent Literature 5: JP-A No. 2004-319464
Patent Literature 6: JP-A No. 2010-92721

### SUMMARY OF INVENTION

### Technical Problem

In a metal-air battery, it is known that a metal oxide (such as LiOₓ) and so on precipitate in an air electrode, at the time of discharge. The inventor of the present invention has found that due to the formation of the precipitates in the air electrode, a liquid electrolyte infiltrated in the air electrode is pushed out of the air electrode. The inventor has also found that when the liquid electrolyte cannot return to the air electrode, which is in an amount that is the same as the amount of the liquid electrolyte pushed out of the air electrode, at the time of charge, the air electrode faces a shortage of the liquid electrolyte and results in a decrease in charge-discharge capacity.

However, in the conventional metal-air battery as disclosed in Patent Literature 1, the liquid electrolyte pushed out of the air electrode at the time of discharge and incorporated into the separator, is unlikely to return to the air electrode at the time of charge, since the separator has higher liquid retention ability than the precipitates formed at the time of discharge. Therefore, for conventional metal-air batteries, rapid liquid electrolyte supply to the air electrode is difficult at the time of charge and results in a decrease in charge-discharge capacity.

The present invention was achieved in light of the above circumstances. An object of the present invention is to provide a metal-air battery which allows rapid and efficient supply of the liquid electrolyte to the air electrode, and an increase in charge-discharge capacity.

### Solution to Problem

The metal-air battery of the present invention is a metal-air battery comprising an air electrode layer, a negative electrode layer and an electrolyte layer, the electrolyte layer being present between the air electrode layer and the negative electrode layer,

wherein the electrolyte layer comprises a separator and a liquid electrolyte, the separator having insulating properties and a porous structure, and the liquid electrolyte being infiltrated in the separator, and

wherein a liquid electrolyte reservoir layer is present between the separator and the air electrode layer, the liquid electrolyte reservoir layer having a porous structure which is larger in pore diameter than the separator.

Because of the above liquid electrolyte reservoir layer, the supply of the liquid electrolyte to the air electrode layer is promoted, so that the metal-air battery of the present invention can obtain high charge-discharge capacity.

Preferably, the pore diameter of the liquid electrolyte reservoir layer is larger than that of the air electrode layer. This is because the supply of the liquid electrolyte from the liquid electrolyte reservoir layer to the air electrode layer is further promoted.

In the metal-air battery of the present invention, there is no particular limitation on the pore diameter of the liquid electrolyte reservoir layer and the separator. As a preferred range, for example, there may be mentioned an embodiment that the pore diameter of the liquid electrolyte reservoir layer is 1 to 50 μm, and the pore diameter of the separator is 0.02 to 1 μm.

Preferably, the liquid electrolyte reservoir layer has a porosity of 50 to 90%. This is because a sufficient amount of the liquid electrolyte can be retained.

Preferably, the liquid electrolyte reservoir layer is electroconductive. This is because the electroconductive liquid electrolyte reservoir layer can also function as the current collector of the air electrode layer and reduce the size of the metal-air battery.

A concrete embodiment of the metal-air battery of the present invention is a lithium-air battery.

### Advantageous Effects of Invention

In the metal-air battery of the present invention, even if a liquid electrolyte is pushed out of an air electrode layer by precipitates formed in the air electrode layer at the time of charge, it is possible to supply the liquid electrolyte rapidly and efficiently to the air electrode layer, at the time of next charge, and to increase charge-discharge capacity. According to the present invention, therefore, it is possible to supply a metal-air battery with high energy density.

### BRIEF DESCRIPTION OF DRAWINGS

FIG. 1 is a schematic sectional view showing a first embodiment of the metal-air battery of the present invention.

FIG. 2 is a schematic sectional view showing a second embodiment of the metal-air battery of the present invention.

FIG. 3 is a schematic sectional view showing a third embodiment of the metal-air battery of the present invention.

FIG. 4 is a sectional SEM image of a layered product comprising an electrolyte reservoir layer and an air electrode layer, the layers being produced in Example 1.

FIG. 5 is a chart showing discharge curves of metal-air batteries of Examples 1 and 2 and Comparative Examples 1 and 2.

### DESCRIPTION OF EMBODIMENTS

The metal-air battery of the present invention is a metal-air battery comprising an air electrode layer, a negative electrode layer and an electrolyte layer, the electrolyte layer being present between the air electrode layer and the negative electrode layer,

wherein the electrolyte layer comprises a separator and a liquid electrolyte, the separator having insulating properties and a porous structure, and the liquid electrolyte being infiltrated in the separator, and

wherein a liquid electrolyte reservoir layer is present between the separator and the air electrode layer, the liquid electrolyte reservoir layer having a porous structure which is larger in pore diameter than the separator.

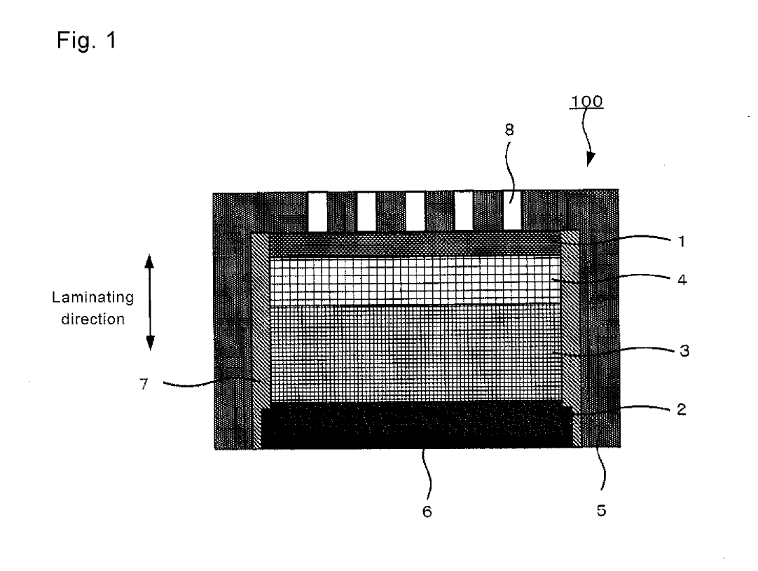

Hereinafter, the metal-air battery of the present invention will be explained, with reference to figures. FIGS. 1 to 3 are schematic sectional views showing embodiments of the metal-air battery of the present invention.

In a metal-air battery 100 of FIG. 1, an air electrode layer 1, a negative electrode layer 2 and an electrolyte layer 3 are stacked so that the electrolyte layer 3 is present between the air electrode layer 1 and the negative electrode layer 2; moreover, a liquid electrolyte is present between the air electrode layer and the negative electrode layer 2. A liquid electrolyte reservoir layer 4 is present between the electrolyte layer 3 and the air electrode layer 1. These air electrode layer 1, liquid electrolyte reservoir layer 4, electrolyte layer 3 and negative electrode layer 2 are stacked in this sequence and stored in a battery case comprising an air electrode can 5 and a negative electrode can 6. The air electrode can 5 and the negative electrode can 6 are fixed by a gasket 7.

The air electrode layer 1 is an electrode reaction layer that uses oxygen as an active material, and it contains an electroconductive material (e.g., carbon black), a catalyst (e.g., manganese dioxide) and a binder (e.g., a copolymer of polytetrafluoroethylene and hexafluoropropylene).

The air electrode layer 1 has a porous structure, and air (oxygen) is supplied to the air electrode layer through air holes 8 of the air electrode can 5.

The negative electrode layer 2 comprises a negative electrode active material (e.g., Li metal) that is able to release/store metal ions (migrating ion species).

The electrolyte layer 3 comprises a separator and a liquid electrolyte, the separator composed of an insulating porous material (e.g., a non-woven fabric made of polypropylene) and the liquid electrolyte (e.g., a propylene carbonate solution of lithium salt) being infiltrated in the separator.

The liquid electrolyte reservoir layer 4 is present between the separator and the air electrode layer 1, the separator constituting the electrolyte layer 3. The liquid electrolyte reservoir layer 4 is composed of a porous structure and infiltrated with the liquid electrolyte, the porous structure having a larger pore diameter than that of the insulating porous material that constitutes the separator (e.g., carbon paper).

The inventor of the present invention has found that in the air electrode layer of the metal-air battery, due to the formation of precipitates at the time of discharge, the liquid electrolyte infiltrated in the air electrode layer is pushed out of the air electrode layer. If the liquid electrolyte cannot return to the air electrode layer, which is in an amount that is the same as the amount of the liquid electrolyte pushed out of the air electrode layer, at the time of charge, the air electrode layer faces a shortage of the liquid electrolyte and results in problem of a decrease in charge-discharge capacity. However, in conventional metal-air batteries, since the separator has higher liquid retention ability and capillary force than the precipitates formed at the time of discharge, the liquid electrolyte pushed out of the air electrode layer and incorporated into the separator is unlikely to return to the air electrode layer, even if the precipitates are decomposed at the time of charge.

Therefore, by providing the liquid electrolyte reservoir layer between the air electrode layer and the separator, the liquid electrolyte reservoir layer having a porous structure with the above-mentioned pore diameter, the present invention has made it possible to promote the supply of the liquid electrolyte to the air electrode layer and to inhibit a shortage of the liquid electrolyte in the air electrode layer. This is because the porous structure which is large in pore diameter than the separator has smaller liquid retention ability and capillary force than the separator, so that the liquid electrolyte incorporated in the porous structure material can move to the air electrode layer more easily than the liquid electrolyte incorporated in the separator.

Meanwhile, when a space (void) that can retain the liquid electrolyte is provided between the air electrode layer and the separator, a similar effect is achieved. In this case, however, there is such a problem that there is an increase in battery size and results in volume loss. Or, there may be a flooding phenomenon in which the air electrode layer keeps soaking up the liquid electrolyte that has accumulated in the space.

As described above, the present invention makes it possible to promote the supply of the liquid electrolyte to the air electrode layer, by providing the porous structure material which has an excellent balance between the capability to supply the liquid electrolyte to the air electrode layer and the capability to store the liquid electrolyte pushed out of the air electrode layer, and which functions very well as a buffer layer of the liquid retention ability and capillary force between the separator and the air electrode layer.

In addition, the liquid electrolyte reservoir layer can efficiently realize an increase in air electrode performance, without preventing the metal-air battery from downsizing.

Hereinafter, the components of the metal-air battery of the present invention will be explained in detail.

In the present invention, “metal-air battery” means the following battery: an oxidation-reduction reaction of oxygen, which is a positive electrode active material, is carried out in the air electrode layer; an oxidation-reduction reaction of metal is carried out in the negative electrode layer; and metal ions are conducted by the electrolyte which is present between the air electrode layer and the negative electrode layer. Examples of metal-air batteries include the following: a lithium-air battery, a sodium-air battery, a potassium-air battery, a magnesium-air battery, a calcium-air battery, a zinc-air battery and an aluminum-air battery. Especially, a lithium-air battery can be said to exert the effect of the present invention because, at the time of discharge, a solid metal oxide (lithium oxide) is likely to precipitate in the air electrode layer and there is a large amount of the liquid electrolyte pushed out of the air electrode layer.

In the present invention, the metal-air battery can be either a primary battery or a secondary battery. Preferred is a secondary battery because it exerts the effects of the present invention, such as an increase in charge-discharge capacity, more powerfully.

Also in the present invention, the pore diameter of the separator, liquid electrolyte reservoir layer and air electrode layer means the minimum diameter of a pore that passes through the layers in the cross-sectional direction of the layers (bottleneck diameter). For example, it can be measured by the bubble point method of permporometry. The bubble point method is a method for obtaining the pore diameter distribution of a porous sample by applying gas pressure to the porous sample wetted with liquid and then gradually increasing the gas pressure to obtain the pore diameter distribution from the gas pressure applied at the time when the liquid contained in the pore is pushed out of the pore. The bubble point method can measure the diameter of a neck part of the porous sample that controls liquid permeability. As used herein, the cross-sectional direction of the layers means the stacking direction of the layers and a layer (member) adjacent to each layer (see the double arrow shown in FIG. 1).

### (Air Electrode Layer)

In general, the air electrode layer comprises at least an electroconductive material and has a porous structure. In the air electrode layer, a reaction of metal ions and supplied oxygen occurs on the surface of the electroconductive material (e.g., formation or decomposition of a metal oxide or metal hydroxide). The voids of the porous structure is infiltrated with the liquid electrolyte and function as a metal ion conducting path and as an oxygen diffusion path. In addition, they function as a storage space for precipitates formed at the time of discharge.

The electroconductive material is not particularly limited as long as it is electroconductive. Examples of electroconductive materials include an electroconductive carbonaceous material.

The electroconductive carbonaceous material is not particularly limited. However, from the viewpoint of the area and space of reaction sites in the air electrode layer, preferred is a carbonaceous material having a high specific surface area. In particular, the electroconductive carbonaceous material preferably has a specific surface area of 10 m²/g or more, more preferably 100 m²/g or more, still more preferably 600 m²/g or more. Concrete examples of electroconductive carbonaceous materials include carbon black, activated carbon and carbon fibers (such as carbon nanotubes and carbon nanofibers). The specific surface area of the electroconductive material can be obtained by the BET method based on nitrogen adsorption measurement.

The electroconductive carbonaceous material can be one having a porous structure or can be one not having a porous structure. However, from the viewpoint of ensuring the space of reaction sites, preferred is one having a porous structure, and particularly preferable is one having a high pore volume of 1 cc/g or more. Concrete examples of electroconductive carbonaceous materials having a high pore volume include carbon black, activated carbon and carbon fibers (such as carbon nanotubes and carbon nanofibers). The pore volume of the electroconductive material can be obtained by the BJH method based on nitrogen adsorption measurement.

The content of the electroconductive material in the air electrode layer varies depending on the density, specific surface area, etc. However, for example, it is preferably in the range of 10% by weight to 99% by weight.

The air electrode layer can also contain an air electrode catalyst to promote oxygen reaction in the air electrode layer. The air electrode catalyst can be supported by the electroconductive material.

The air electrode catalyst is not particularly limited. The examples include organic and inorganic materials. The organic material examples include the following: phthalocyanine compounds such as cobalt phthalocyanine, manganese phthalocyanine, nickel phthalocyanine, tin phthalocyanine oxide, titanium phtalocyanine and dilithium phthalocyanine; naphthocyanine compounds such as cobalt naphthocyanine; and porphyrin compounds such as iron porphyrin. The inorganic material examples include the following: metal oxides such as MnO₂, CeO₂, CO₃O₄, NiO, V₂O₅, Fe₂O₃, ZnO, CuO, LiMnO₂, Li₂MnO₃, LiMn₂O₄, Li₄Ti₅O₁₂, Li₂TiO₃, LiNi_{1/3}CO_{1/3}Mn_{1/3}O₂, LiNiO₂, LiVO₃, Li₅FeO₄, LiFeO₂, LiCrO₂, LiCoO₂, LiCuO₂, LiZnO₂, Li₂MoO₄, LiNbO₃, LiTaO₃, Li₂WO₄, Li₂ZrO₃, NaMnO₂, CaMnO₃, CaFeO₃, MgTiO₃ and KMnO₂; and noble metals such as Au, Pt and Ag. Complexes of the above materials can be also used as the air electrode catalyst.

Preferably, the content of the air electrode catalyst in the air electrode layer is in the range of 1% by weight to 90% by weight, for example.

From the viewpoint of fixing the electroconductive material and the air electrode catalyst, it is preferable that the air electrode layer further comprises a binder.

Examples of binders include the following: polyvinylidene fluoride (PVdF), a copolymer of PVdF and hexafluoropropylene (HFP), polytetrafluoroethylene (PTFE) and styrene-butadiene rubber (SBR).

Preferably, the content of the binder in the air electrode layer is in the range of 1% by weight to 40% by weight, for example.

The thickness of the air electrode layer varies depending on the intended use, etc., of the metal-air battery. For example, it is preferably in the range of 2 μm to 500 μm, particularly preferably in the range of 5 μm to 300 μm.

The pore diameter of the porous structure of the air electrode layer is not particularly limited. However, for example, it is preferably in the range of 0.02 to 1 μm, particularly preferably in the range of 0.05 to 0.2 μm.

The air electrode layer can be provided with an air electrode current collector for collecting current from the air electrode layer.

The air electrode current collector can have a porous structure or a dense structure, as long as it has desired electron conductivity. However, from the viewpoint of air (oxygen) diffusivity, it preferably has a porous structure. Examples of porous structures include the following: a mesh structure in which constituent fibers are regularly arranged; a non-woven fabric structure in which constituent fibers are randomly arranged; and a three-dimensional network structure having independent holes and connecting holes. The porosity of the current collector having a porous structure is not particularly limited; however, it is preferably in the range of 20 to 99%, for example.

The position of the air electrode current collector is not particularly limited, as long as it is electrically connected to the air electrode layer.

The air electrode current collector can be provided on a side of the air electrode layer, which is opposite to the liquid electrolyte reservoir layer side of the air electrode layer. In the case of using an air electrode current collector having a porous structure, it can be provided inside the air electrode layer.

Examples of materials for the air electrode current collector include the following: metallic materials such as stainless steel, nickel, aluminum, iron, titanium and copper; carbonaceous materials such as carbon fibers, carbon papers and carbon cloths; and high electron conductive ceramic materials such as titanium nitride. In particular, preferred as the air electrode current collector are porous structures such as carbon papers, carbon cloths and metal mesh. Particularly preferred is porous carbon.

The thickness of the air electrode current collector is not particularly limited. However, for example, it is preferably in the range of 10 μm to 1,000 μm, particularly preferably in the range of 20 to 400 μm.

The below-described battery case of the metal-air battery can also function as the current collector of the air electrode. When the below-described liquid electrolyte reservoir layer is electroconductive, the reservoir layer is allowed to also function as the air electrode current collector. When the liquid electrolyte reservoir layer is allowed to function as the air electrode current collector, it is possible to reduce the size and constituent members of the metal-air battery, for example.

The method for producing the air electrode layer is not particularly limited. For example, the air electrode layer can be formed with a material for the air electrode layer, the material comprising a mixture of the electroconductive material and other raw materials such as the binder. In particular, a layered product composed of the air electrode layer and the liquid electrolyte reservoir layer can be produced by applying the material for the air electrode layer, the material comprising a solvent, to a surface of a porous material that constitutes the below-described liquid electrolyte reservoir layer, and then performing a drying treatment, pressure treatment, heating treatment, etc., on the applied material, as needed. Or, the air electrode layer can be produced by roll-pressing or applying the material for the air electrode layer comprising a solvent on a substrate and then performing a drying treatment, pressure treatment, heating treatment, etc., as needed. It is also allowed to form the air electrode layer that already contains a liquid electrolyte or a liquid electrolyte solvent, by using the material for the air electrode layer mixed with a liquid electrolyte or a liquid electrolyte solvent. In this case, as the liquid electrolyte and the liquid electrolyte solvent, there may be used the below-described liquid electrolyte and a non-aqueous solvent used for the liquid electrolyte.

The air electrode layer produced as above can be appropriately placed on or below the air electrode current collector and/or the porous material for the liquid electrolyte reservoir layer and then laminated by pressure, heating, etc., as needed.

The solvent used for the material for the air electrode layer is not particularly limited and can be appropriately selected, as long as it is volatile. Concrete examples thereof include acetone, N,N-dimethylformamide (DMF) and N-methyl-2-pyrrolidone (NMP). Preferred is a solvent having a boiling point of 200° C. or less, since such a solvent makes it easy to dry the material for the air electrode layer.

The method for applying the material for the air electrode layer is not particularly limited. There may be used general methods such as a doctor blade method, an ink-jet method, a spraying method, etc.

### (Electrolyte Layer)

The electrolyte layer comprises a separator and a liquid electrolyte, the separator having insulating properties and a porous structure, and the liquid electrolyte being infiltrated in the separator.

The separator is not particularly limited as long as it has insulation properties that can insulate the air electrode layer and the negative electrode layer from each other, and a porous structure that can retain the liquid electrolyte. The separator can be selected from known materials and porous structures. Examples of materials for the separator include glass and insulating resins such as polyethylene and polypropylene. Examples of porous structures for the separator include the following: a mesh structure in which constituent fibers are regularly arranged; a non-woven fabric structure in which constituent fibers are randomly arranged; and a three-dimensional network structure having independent holes and connecting holes.

The pore diameter of the separator is not particularly limited. However, from the viewpoint of liquid retention properties, for example, it is preferably 0.02 to 1 μm, particularly preferably 0.05 to 0.2 μm.

The thickness of the separator is not particularly limited and can be about 10 to 500 μm, for example.

The liquid electrolyte infiltrated in the separator is not particularly limited as long as it can conduct metal ions between the air electrode layer and the negative electrode layer. It can be a non-aqueous liquid electrolyte that contains a supporting electrolyte salt and a non-aqueous solvent, or it can be an aqueous liquid electrolyte that contains a supporting electrolyte salt and an aqueous solvent. In the case of using the non-aqueous liquid electrolyte, precipitates are likely to be generated in the air electrode layer. Therefore, it can be said that the metal-air battery of the present invention exerts great effects when the non-aqueous liquid electrolyte is used.

The non-aqueous solvent is not particularly limited, and the examples include the following: propylene carbonate (PC), ethylene carbonate (EC), vinylene carbonate, dimethyl carbonate (DMC), ethyl methyl carbonate (FMC), diethyl carbonate (DEC), methyl propyl carbonate, isopropiomethyl carbonate, ethyl propionate, methyl propionate, γ-butyrolactone, ethyl acetate, methyl acetate, tetrahydrofuran, 2-methyltetrahydrofuran, ethylene glycol dimethyl ether, ethylene glycol diethyl ether, acetonitrile (AcN), dimethylsulfoxide (DMSO), diethoxyethane, dimethoxyethane (DME) and tetraethylene glycol dimethyl ether (TEGDME).

Also, an ionic liquid can be used as the non-aqueous solvent. Examples of ionic liquids include the following: aliphatic quaternary ammonium salts such as N,N,N-trimethyl-N-propylammonium bis(trifluoromethanesulfonyl)amide [abbreviation: TMPA-TFSA], N-methyl-N-propylpiperidinium bis(trifluoromethanesulfonyl)amide [abbreviation: PP13-TFSA], N-methyl-N-propylpyrrolidinium bis(trifluoromethanesulfonyl)amide [abbreviation: P13-TFSA], N-methyl-N-butylpyrrolidinium bis(trifluoromethanesulfonyl)amide [abbreviation: P14-TFSA] and N,N-diethyl-N-methyl-N-(2-methoxyethyl)ammonium bis(trifluoromethanesulfonyl)amide [abbreviation: DEME-TFSA]; and alkylimidazolium quaternary salts such as 1-methyl-3-ethylimidazolium tetrafluoroborate [abbreviation: EMIBF₄], 1-methyl-3-ethylimidazolium bis(trifluoromethanesulfonyl)amide [abbreviation: EMITFSA], 1-allyl-3-ethylimidazolium bromide [abbreviation: AEImBr], 1-allyl-3-ethylimidazolium tetrafluoroborate [abbreviation: AEImBF₄], 1-allyl-3-ethylimidazolium bis(trifluoromethanesulfonyl)amide [abbreviation: AEImTFSA], 1,3-diallylimidazolium bromide [abbreviation: AAImBr], 1,3-diallylimidazolium tetrafluoroborate [abbreviation: AAImBF₄] and 1,3-diallylimidazolium bis(trifluoromethanesulfonyl)amide [abbreviation: AAImTFSA].

From the viewpoint of electrochemical stability to oxygen radicals, AcN, DMSO, DME, PP13-TFSA, P13-TFSA, P14-TFSA, TMPA-TFSA, DEME-TFSA and so on are preferable as the non-aqueous solvent.

In the non-aqueous liquid electrolyte, the supporting electrolyte salt is required to be soluble in non-aqueous solvents and exhibit desired metal ion conductivity. In general, there may be used a metal salt that contains metal ions required to be conducted. For example, in the case of lithium-air battery, a lithium salt can be used as the supporting electrolyte salt. As the lithium salt, there may be mentioned inorganic lithium salts such as LiPF₆, LiBF₄, LiClO₄, LiAsF₆, LiOH, LiCl, LiNO₃ and Li₂SO₄. Also, there may be used organic lithium salts such as CH₃CO₂Li, lithium bis(oxalate)borate (abbreviation: LiBOB), LiN(CF₃SO₂)₂ (abbreviation: LiTFSA), LiN(C₂F₅SO₂)₂ (abbreviation: LiBETA) and LiN(CF₃SO₂) (C₄F₉SO₂).

In the non-ionic liquid electrolyte, the content of the supporting electrolyte salt with respect to the non-aqueous solvent is not particularly limited. However, for example, the concentration of the lithium salt can be in the range of 0.5 mol/L to 3 mol/L, for instance.

In the aqueous liquid electrolyte, the supporting electrolyte salt is not particularly limited as long as it is soluble in water and exhibit desired ion conductivity. In general, there may be used a metal salt that contains metal ions required to be conducted. For example, in the case of lithium-air battery, there may be used lithium salts such as LiOH, LiCl, LiNO₃, Li₂SO₄ and CH₃COOLi.

The liquid electrolyte can be gelled or can contain a solid electrolyte.

For example, for gelation of the non-aqueous liquid electrolyte, there may be mentioned a method for adding a polymer such as polyethylene oxide (PEO), polyacrylonitrile (PAN), polyvinylidene fluoride (PVDF) or polymethyl methacrylate (PMMA) to the non-aqueous liquid electrolyte.

The solid electrolyte can be appropriately selected depending on metal ions to be conducted and is not particularly limited. For example, in the case of lithium-air battery, there may be mentioned the following: NASICON oxides described by LiₐX_{b}Y_{c}P_{d}Oₑ, (X is at least one selected from the group consisting of B, Al, Ga, In, C, Si, Ge, Sn, Sb and Se; Y is at least one selected from the group consisting of Ti, Zr, Ge, In, Ga, Sn and Al; and “a” to “e” satisfy the following formulae: 0.5<a<5.0, 0≦b<2.98, 0.5≦c<3.0, 0.02<d≦3.0, 2.0<b+d<4.0 and 3.0<e≦12.0); perovskite oxides such as LiₓLa₁₋ₓTiO₃; LISICON oxides such as Li₄XO₄—Li₃YO₄ (X is at least one selected from Si, Ge and Ti, and Y is at least one kind selected from P, As and V) and Li₃DO₃—Li₃YO₄ (D is B, and Y is at least one selected from P, As and V); and garnet oxides including Li—La—Zr—O oxides such as Li₇La₃Zr₂O₁₂.

### (Liquid Electrolyte Reservoir Layer)

The liquid electrolyte reservoir layer is provided between the air electrode layer and the separator which constitutes a part of the electrolyte layer. That is, the liquid electrolyte reservoir layer is in contact with both the air electrode layer and the separator. Typically, the air electrode, the liquid electrolyte reservoir layer and the separator are stacked in this sequence and each of the layers is infiltrated with the liquid electrolyte.

The liquid electrolyte reservoir layer has a porous structure, and the pore diameter is larger than that of the separator which constitutes a part of the electrolyte layer. The pore diameter of the liquid electrolyte reservoir layer is only required to be larger than that of the separator. However, it is preferably larger than that of the air electrode layer, because the liquid electrolyte incorporated in the liquid electrolyte reservoir layer can be efficiently supplied to the air electrode layer.

The specific pore diameter of the liquid electrolyte reservoir layer is not particularly limited. However, from the viewpoint of capillary force as a driving force for supplying the liquid electrolyte to the air electrode layer, for example, it is preferably 1 to 50 μm, particularly preferably 10 to 40 μm.

The porous structure of the liquid electrolyte reservoir layer is not particularly limited. Examples of porous structures include the following: a mesh structure in which constituent fibers are regularly arranged; a non-woven fabric structure in which constituent fibers are randomly arranged; and a three-dimensional network structure having independent holes and connecting holes.

The material for the porous structure of the liquid electrolyte reservoir layer is not particularly limited, and there may be used an insulting material such as polypropylene. However, the material is preferably electroconductive because, in this case, the liquid electrolyte reservoir layer can also function as the current collector for the air electrode layer. Examples of electroconductive materials for the liquid electrolyte reservoir layer include the following: metallic materials such as stainless steel, nickel, aluminum, iron, titanium and copper; carbonaceous materials such as carbon fibers, carbon papers and carbon cloths; and high electron conductive ceramic materials such as titanium nitride. Particularly preferred are carbonaceous porous materials that contain carbon fibers, such as carbon papers and carbon cloths.

The porosity of the liquid electrolyte reservoir layer is not particularly limited. However, to retain a sufficient amount of the liquid electrolyte, for example, it is preferably 50 to 90%, particularly preferably 70 to 90%. The porosity of the liquid electrolyte reservoir layer can be measured by mercury intrusion porosimetry, for example.

The thickness of the liquid electrolyte reservoir layer is not particularly limited and can be about 2 to 500 μm, for example.

### (Negative Electrode Layer)

The negative electrode layer comprises a negative electrode active material that can release/store metal ions (migrating ions). A negative electrode current collector for collecting current from the negative electrode layer can be provided to the negative electrode layer.

The negative electrode active material is not particularly limited as long as it is able to release/store migrating ion species, typically metal ions. The examples include elemental metals, alloys, metal oxides, metal sulfides and metal nitrides, all of which contains metal ions (migrating ion species). Also, carbonaceous materials can be used as the negative electrode active material. Preferred are elemental metals and alloys, and particularly preferred are elemental metals. Examples of elemental metals include the following: lithium, sodium, potassium, magnesium, calcium, aluminum, zinc and iron. Examples of alloys include those comprising at least one of the elemental metals.

More specifically, as the negative electrode active material for lithium-air battery, there may be mentioned the following: lithium metal; lithium alloys such as lithium-aluminum alloy, lithium-tin alloy, lithium-lead alloy and lithium-silicon alloy; metal oxides such as tin oxide, silicon oxide, lithium-titanium oxide, niobium oxide, and tungsten oxide; metal sulfides such as tin sulfide and titanium sulfide; metal nitrides such as lithium-cobalt nitride, lithium-iron nitride and lithium-manganese nitride; and carbonaceous materials such as graphite. Preferred are lithium metal and carbonaceous materials. From the viewpoint of higher capacity, lithium metal is more preferred.

The negative electrode layer is required to comprise at least the negative electrode active material. As needed, it can comprise a binder that can fix the negative electrode active material. For example, in the case of using a metal foil or alloy foil as the negative electrode active material, the negative electrode layer can be in a form that contains only the negative electrode active material. However, when the negative electrode active material is in a powdery form, the negative electrode layer can be in a form that contains the negative electrode active material and the binder. The negative electrode layer can also contain an electroconductive material. The type and amount of the binder and the electroconductive material can be the same as those of the air electrode layer described above.

The material for the negative electrode current collector is not particularly limited as long as it is electroconductive. The examples include copper, stainless-steel and nickel, and preferred are stainless-steel and nickel. As the form of the negative electrode current collector, there may be mentioned a foil form, a plate form and a mesh form, for example. The battery case can also have a function as the negative electrode current collector.

The method for producing the negative electrode layer and the negative electrode current collector is not particularly limited. For example, a negative electrode in which the negative electrode layer and the negative electrode current collector are stacked, can be produced by stacking the negative electrode active material in a foil form and the negative electrode current collector and then pressing them. Or, a negative electrode in which the negative electrode layer and the negative electrode current collector are stacked, can be produced by preparing a material for negative electrode layer, the material containing the negative electrode active material, the binder, etc., applying the material onto a substrate (such as the negative electrode current collector) and drying the same.

### (Others)

The metal-air battery of the present invention can comprise other components, in addition to the above-mentioned air electrode layer, liquid electrolyte reservoir layer, electrolyte layer and negative electrode layer.

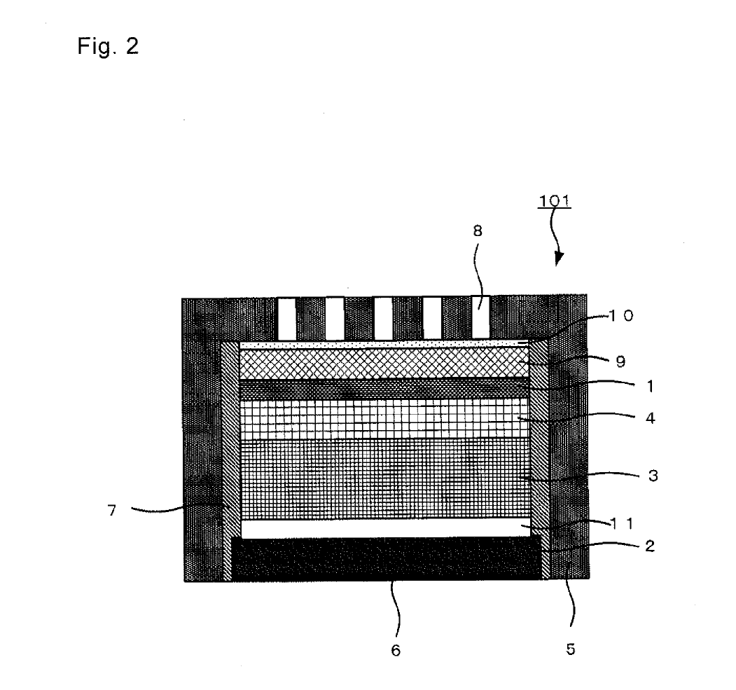

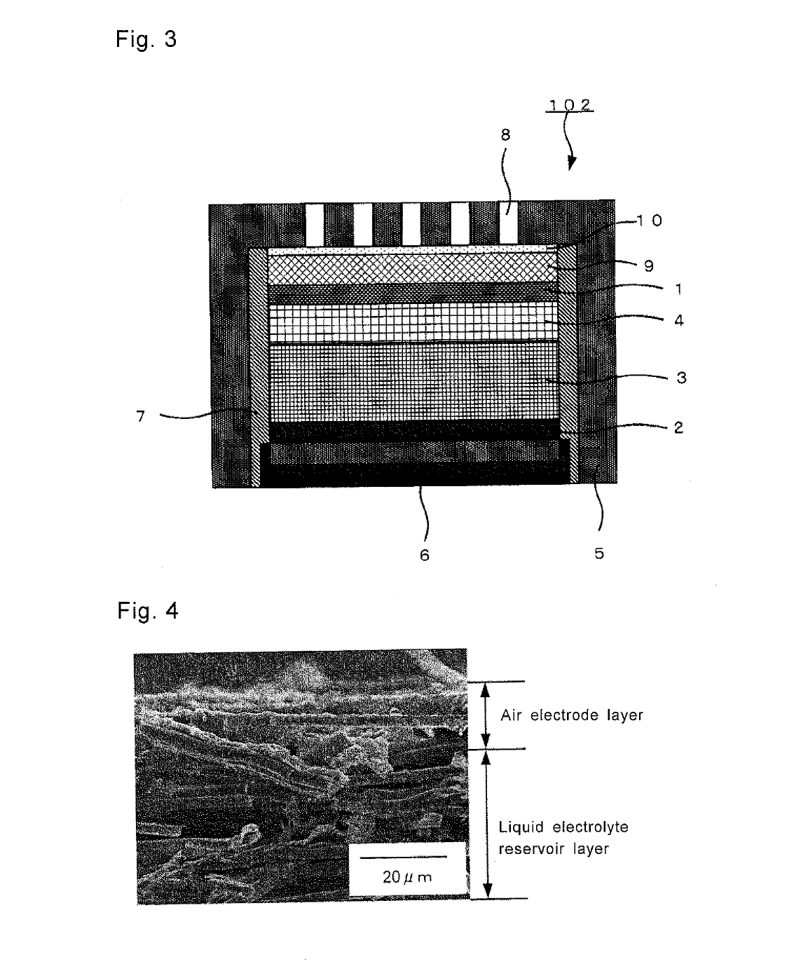

For example, in the metal-air battery 101 shown in FIG. 2 and in the metal-air battery 102 shown in FIG. 3, on the side opposite to the liquid electrolyte reservoir layer 4 side of the air electrode layer 1, an air reservoir layer 9 is provided, the air reservoir layer 9 being provided adjacent to the air electrode layer 1. The air reservoir layer 9 has a structure that can store oxygen which will be supplied to the air electrode layer, and it can consist of a porous material, for example. The porous material constituting the air reservoir layer can be electroconductive or insulating. Examples of porous materials for the porous air reservoir layer include porous materials made of polyethylene, polypropylene, polytetrafluoroethylene, carbon paper, carbon cloth, etc. The air reservoir layer preferably has a thickness of about 2 to 500 μm, for example.

Like the metal-air battery 101 shown in FIG. 2, a negative electrode protection layer 11 can be provided between the negative electrode layer 2 and the electrolyte layer 3. The negative electrode protection layer 11 has a liquid reservoir structure (gap) that can retain liquid electrolyte. By providing such a negative electrode protection layer 11, it is possible to moderate an increase and decrease in the liquid electrolyte of the whole battery.

In general, the metal-air battery of the present invention comprises a battery case for storing the air electrode layer, the negative electrode and the electrolyte layer. The form of the battery case is not particularly limited; however, concrete examples thereof include a coin form, a flat plate form, a laminate form, etc. The battery case can be an open-to-the-atmosphere battery case or a closed battery case.

The open battery case has such a structure that at least the air electrode layer can be sufficiently exposed to oxygen. For example, like the metal-air batteries 100, 101 and 102 shown in FIGS. 1 to 3, there may be mentioned a structure of having air inlet holes 8 that communicate with the air electrode layer 1. Like the metal-air battery 101 shown in FIG. 2 and the metal-air battery 102 shown in FIG. 3, an oxygen permeable membrane 10 can be provided to the air inlet holes 8, which can selectively let oxygen through. Preferably, the oxygen permeable membrane 10 can prevent water (water vapor) or carbon dioxide in the air from entering the battery case. Concrete examples of oxygen permeable membranes include polysiloxane membranes. Also, a water-repellent membrane such as polytetrafluoroethylene membrane can be provided to the air inlet holes. Or, the oxygen permeable membrane is allowed to function as a water-repellent membrane.

On the other hand, the closed battery case can be provided with oxygen (air) inlet and outlet tubes, the oxygen (air) being a positive electrode active material.

It is preferable that the oxygen supplied to the metal-air battery has a high oxygen concentration. It is particularly preferable that the introduced oxygen is pure oxygen.

In the case where the metal-air battery has such a structure that a plurality of layered products are stacked (e.g., a layered structure or wound structure), each of the products being composed of the air electrode layer, the liquid electrolyte reservoir layer, the electrolyte layer and the negative electrode layer in this sequence, it is preferable to provide a separator between the air electrode and the negative electrode, from the viewpoint of safety, the electrodes belonging to different layered products. Examples of such a separator include porous membranes made of polyethylene, polypropylene and the like, non-woven fabrics such as a resin non-woven fabric and a glass fiber non-woven fabric, etc.

A terminal can be provided to each of the air electrode current collector and the negative electrode current collector, which serves as a connection to the outside.

The method for producing the metal-air battery of the present invention is not particularly limited, and there may be used a general method.

### EXAMPLES

### Production of Metal-Air Battery

### Example 1

A lithium-air battery was produced as follows, which is in the form shown in FIG. 2. In the following lithium-air battery, however, a negative electrode current collector was provided on the outer surface side of a negative electrode layer.

A polytetrafluoroethylene membrane was used as an air reservoir layer.

Carbon black (“Super P” manufactured by TIMCAL Ltd.) (electroconductive material), MnO₂ (manufactured by Mitsui Mining & Smelting Co., Ltd.) (catalyst) and a PVdF-HFP copolymer (“Kynar 2801” manufactured by Arkema) (binder) were mixed at a weight ratio of 25:42:33 in an acetone solvent and then stirred, thus preparing an air electrode layer slurry. The slurry was applied onto a carbon paper (“TGP-H-90” manufactured by Toray Industries, Inc., pore diameter 30 μm, porosity 80%) (electroconductive porous material) by doctor blade method and dried. The thus-obtained coating product was cut to obtain a layered product composed of an air electrode layer and a liquid electrolyte reservoir layer (pore diameter 30 μm).

The pore diameter of an air electrode layer produced in the same manner as above, was measured by permporometry and found to be 120 nm.

Under an Ar atmosphere, LiTFSA (lithium bis(trifluoromethanesulfonyl)amide manufactured by Kishida Chemical Co., Ltd.) (lithium salt) was added to propylene carbonate (manufactured by Kishida Chemical Co., Ltd.) (non-aqueous solvent) to a concentration of 1 mol/L. The mixture was stirred overnight, thus obtaining a non-aqueous liquid electrolyte.

As a separator, a non-woven fabric made of polypropylene (pore diameter 50 nm) was used.

To form a negative electrode protection layer (space), a PEEK ring was used.

A SUS304 foil (manufactured by Nilaco Corporation) (current collector) was attached to Li metal (manufactured by Honjo Metal Co., Ltd.) (negative electrode active material) to obtain a negative electrode. The negative electrode is a layered product composed of the negative electrode layer and the negative electrode current collector.

A battery case was used, which has oxygen inlet holes on the air electrode side. An oxygen permeable membrane (polytetrafluoroethylene membrane) was provided inside the battery case surface provided with the oxygen inlet holes.

The air reservoir layer, air electrode layer, liquid electrolyte reservoir layer, separator, negative electrode protection layer, negative electrode layer and negative electrode current collector were stored in the battery case so that they are stacked in this sequence from closest to the oxygen inlet hole side (oxygen permeable membrane side). The liquid electrolyte reservoir layer, separator and negative electrode protection layer were filled with the non-aqueous liquid electrolyte, thus producing the lithium-air battery.

### Comparative Example 1

A lithium-air battery was produced in the same manner as Example 1, except that the air electrode layer was produced as follows and the liquid electrolyte reservoir layer was not provided. In particular, the air electrode layer was produced by applying an air electrode layer slurry, which is similar to that of Example 1, onto a glass substrate, drying the applied slurry, peeling the thus-obtained coating product off the glass substrate and then cutting the product.

### Example 2

A lithium-air battery was produced as follows, which is in the form shown in FIG. 3. In the following lithium-air battery, however, a negative electrode current collector was provided on the outer surface side of a negative electrode layer.

A polytetrafluoroethylene membrane was used as an air reservoir layer.

Ketjen Black (“ECP600JD” manufactured by Ketjen Black International Company) (electroconductive material), a PVdF-HFP copolymer (“Kynar 2801” manufactured by Arkema) (binder) and PP13TFSA (N-methyl-N-propylpiperidinium bis(trifluoromethanesulfonyl)amide manufactured by Kanto Chemical Co., Inc.) (non-aqueous solvent) were mixed at a weight ratio of 25:15:60 and then stirred, thus preparing an air electrode layer slurry. The slurry was applied onto a carbon paper (“TGP-H-30” manufactured by Toray Industries, Inc., pore diameter 30 μm, porosity 78%) (electroconductive porous material) by doctor blade method and dried. The thus-obtained coating product was cut to obtain a layered product composed of an air electrode layer and a liquid electrolyte reservoir layer (pore diameter 30 μm).

The pore diameter of an air electrode layer produced in the same manner as above, was measured by permporometry and found to be 120 nm.

Under an Ar atmosphere, LiTFSA (manufactured by Kishida Chemical Co., Ltd.) (lithium salt) was added to PP13TFSA (manufactured by Kanto Chemical Co., Inc.) (non-aqueous solvent) to a concentration of 0.32 g/kg. The mixture was stirred overnight, thus obtaining a non-aqueous liquid electrolyte.

As a separator, a non-woven fabric made of polypropylene (pore diameter 50 nm) was used.

A SUS304 foil (manufactured by Nilaco Corporation) (current collector) was attached to Li metal (manufactured by Honjo Metal Co., Ltd.) (negative electrode active material) to obtain a negative electrode. The negative electrode is a layered product composed of the negative electrode layer and the negative electrode current collector.

A battery case was used, which has oxygen inlet holes on the air electrode side. An oxygen permeable membrane (polytetrafluoroethylene membrane) was provided inside the battery case surface provided with the oxygen inlet holes.

The air reservoir layer, air electrode layer, liquid electrolyte reservoir layer, separator, negative electrode layer and negative electrode current collector were stored in the battery case so that they are stacked in this sequence from closest to the oxygen inlet hole side (oxygen permeable membrane side). The liquid electrolyte reservoir layer and separator were filled with the non-aqueous liquid electrolyte, thus producing the lithium-air battery.

### Comparative Example 2

A lithium-air battery was produced in the same manner as Example 2, except that the air electrode layer was produced as follows and the liquid electrolyte reservoir layer was not provided. In particular, the air electrode layer was produced by applying an air electrode layer slurry, which is similar to that of Example 2, onto a glass substrate, drying the applied slurry, peeling the thus-obtained coating product off the glass substrate and then cutting the product.

### [Evaluation of Metal-Air Battery]

The lithium-air batteries of Examples and Comparative Examples were evaluated as follows.

### Example 1 and Comparative Example 1

A gas replacement operation was repeated 15 times, in which the inside of the battery case was depressurized to 60 kPa and then argon gas was enclosed (purge) in the battery to seal the argon gas in the battery case with the argon gas. Thereafter, the argon gas inside the battery case was sufficiently replaced by oxygen gas (pure oxygen, manufactured by Taiyo Nippon Sanso Corporation, 99.9%). Then, the lithium-air battery was left to stand for 3 hours at 25° C.

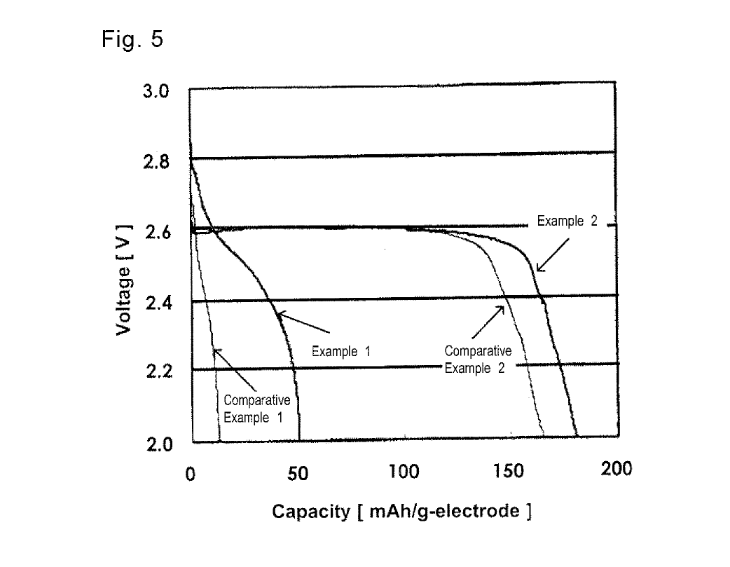

Thereafter, constant current charge-discharge measurement of the battery was conducted under an oxygen atmosphere (pure oxygen, manufactured by Taiyo Nippon Sanso Corporation, 99.9%) at 0.02 mA/cm² and 25° C. to measure the initial discharge capacity per unit weight of the air electrode layer. The discharge cutoff voltage was set to 2.0 V. The results are shown in Table 1 and FIG. 5.

TABLE 1

| | Liquid | | | |
|---|---|---|---|---|
| | electrolyte | Current | | Discharge |
| | reservoir | density | Temperature | capacity |
| | layer | [mA/cm²] | [° C.] | [mAh/g] |
| Example 1 | Used | 0.02 | 25 | 50 |
| Comparative | Not used | 0.02 | 25 | 13 |
| Example 1 | | | | |

### Example 2 and Comparative Example 2

Example 2 and Comparative Example 2 were evaluated in the same manner as Example 1 and Comparative Example 1, except that the standing temperature and constant current charge-discharge measurement temperature were changed to 60° C. and the current density for the constant current charge-discharge measurement was changed to 0.05 mA/cm². The results are shown in Table 2 and FIG. 5.

TABLE 2

| | Liquid | | | |
|---|---|---|---|---|
| | electrolyte | Current | | Discharge |
| | reservoir | density | Temperature | capacity |
| | layer | [mA/cm²] | [° C.] | [mAh/g] |
| Example 2 | Used | 0.05 | 60 | 181 |
| Comparative | Not used | 0.05 | 60 | 165 |
| Example 2 | | | | |

From Tables 1 and 2 and FIG. 5, it was found that the metal-air batteries of Examples 1 and 2, in each of which the liquid electrolyte reservoir layer was provided adjacent to the air electrode layer and the reservoir layer had a porous structure that is larger in pore diameter than the separator, were larger in discharge capacity than Comparative Examples 1 and 2. The reason is presumed to be that the supply of the liquid electrolyte to the air electrode layer was promoted by the formation of the liquid electrolyte reservoir layer. More specifically, it is thought that in the metal-air batteries of Examples, the transfer of the liquid electrolyte from the separator side to the air electrode layer was promoted more effectively than the metal-air batteries of Comparative Examples, during both the gas replacement operation and the battery standing process, each of which was conducted before the constant current charge-discharge measurement; therefore, there was an increase in the initial discharge capacity. That is, in the metal-air batteries, the transfer of the liquid electrolyte was carried out in such a manner that by repeating depressurization and gas purge by the gas replacement operation and then leaving the battery to stand, the liquid electrolyte in the separator and liquid electrolyte reservoir layer was transferred to the air electrode layer, or the liquid electrolyte in the air electrode layer was transferred to the liquid electrolyte reservoir layer and separator. That is, it is thought that during the gas replacement operation and the battery standing process, compared to Comparative Examples 1 and 2, in the metal-air batteries of Examples 1 and 2, the transfer of the liquid electrolyte to the air electrode layer was promoted and the liquid electrolyte infiltration condition in the air electrode layer was improved, so that the initial discharge capacity was increased.

In the constant current charge-discharge measurement, the initial discharge capacity was evaluated. However, due to the increase in the initial discharge capacity, it is presumed that Examples 1 and 2 show better charge-discharge capacity than Comparative Examples 1 and 2, even after charge-discharge cycles.

Also in Examples 1 and 2, the pore diameter of the liquid electrolyte reservoir layer is larger than that of the air electrode layer; therefore, it is thought that the supply of the liquid electrolyte from the liquid electrolyte reservoir layer to the air electrode layer was promoted more effectively.

The constant current charge-discharge measurement of Example 2 and Comparative Example 2 was conducted under a higher temperature and higher current density condition than Example 1 and Comparative Example 1. Under the higher temperature and higher current density condition, the liquid electrolyte showed low viscosity and the condition was a heavy load; therefore, the transfer of the liquid electrolyte was promoted. Nevertheless, Example 2 showed better effects than Comparative Example 2.

### REFERENCE SIGNS LIST

1. Air electrode layer
2. Negative electrode layer
3. Electrolyte layer
4. Liquid electrolyte reservoir layer
5. Air electrode can
6. Negative electrode can
7. Gasket
8. Air inlet holes
9. Air reservoir layer
10. Oxygen permeable membrane
11. Negative electrode protection layer
100. Metal-air battery
101. Metal-air battery
102. Metal-air battery

1. A metal-air battery comprising an air electrode layer, a negative electrode layer and an electrolyte layer, the electrolyte layer being present between the air electrode layer and the negative electrode layer,
wherein the electrolyte layer comprises a separator and a liquid electrolyte, the separator having insulating properties and a porous structure, and the liquid electrolyte being infiltrated in the separator, and
wherein a liquid electrolyte reservoir layer is present between the separator and the air electrode layer, the liquid electrolyte reservoir layer having a porous structure which is larger in pore diameter than the separator and the air electrode layer.

2. (canceled)

3. The metal-air battery according to claim 1, wherein the pore diameter of the liquid electrolyte reservoir layer is 1 to 50 μm, and the pore diameter of the separator is 0.02 to 1 μm.

4. The metal-air battery according to claim 1, wherein the liquid electrolyte reservoir layer has a porosity of 50 to 90%.

5. The metal-air battery according to claim 1, wherein the liquid electrolyte reservoir layer is electroconductive.

6. The metal-air battery according to claim 1, being a lithium-air battery.
